(19) United States
(12) Patent Application Publication
(10) Pub. No.: US 2012/0328811 A1
(43) Pub. Date: Dec. 27, 2012

(54) Epoxy Resin Compositions

(75) Inventors: Pritesh G. Patel, Breinigsville, PA (US); Peter Andrew Lucas, Allentown, PA (US); Jian Li, Beijing (CN); Williams Rene Edouard Raymond, New Tripoli, PA (US)

(73) Assignee: Air Products and Chemicals, Inc., Allentown, PA (US)

(21) Appl. No.: 13/168,174

(22) Filed: Jun. 24, 2011

(51) Int. Cl. C08L 63/00; C08K 3/04; C08L 23/06; C08K 5/1545; C09D 163/00; C09J 163/00; B32B 1/08; C08G 59/50; C08L 77/00; B82Y 30/00

(52) U.S. Cl. 428/36.9; 528/408; 523/400; 523/468; 525/187; 525/449; 523/447; 977/742

(57) ABSTRACT

An epoxy resin composition having a curing component and an epoxy component is disclosed. The curing component includes an amount of about 8% to about 70% by weight of the composition of a primary curing agent and about 0.001% to about 5% by weight of the composition of a secondary curing agent. The epoxy composition also includes about 30% to about 92% by weight of the composition of the epoxy component. A number of equivalents of reactive curative groups in the curing component is from about 0.50 to 0.98 times the number of epoxide equivalents present in the epoxy component. An epoxy product formed from the epoxy resin composition is also disclosed.

### BACKGROUND OF THE INVENTION

The present disclosure relates generally to an epoxy resin composition for manufacturing composite parts and, more particularly, to a curing component that increases the thermal, mechanical and chemical properties of cured epoxy and epoxy composite parts.

Polymer composites offer several advantages compared to metals and ceramics in that polymer composites are lightweight, have high specific stiffness and strength, are easy to manufacture, allow tailoring of the properties by varying the resin's chemistry, reinforcement fibers, and design flexibility for different applications and also have low coefficients of thermal expansion.

Polymer composites, in particular thermosetting polymer material, prepared through crosslinking reaction with an appropriate curing agent, based on amine or polyamine(s), and with an epoxy resin desirably have the following properties: (a) low to high curing temperature, where the curing reaction can be carried out at a temperature of 5 to 150° C.; (b) low volume shrinkage rate, where the volume shrinkage rate of cured epoxy resin is typically 1 to 3% resulting in low internal stress in fiber matrix composites; (c) good wetting, adhesion to provide good shear strength between fiber and matrix; (d) good insulating properties; (e) good chemical resistance; and (f) good thermal properties.

The properties of cured epoxy systems allow their use in various fields and they are extensively used in industry such as adhesive, coating, and composite applications.

Many composite applications require a high degree of resistance to heat. Epoxy amine systems develop relative high glass transition temperature (Tg) (about 150° C.) when cured at high temperature (about 150° C.). However, higher Tg (greater than 170° C.) is desired for many applications to successfully replace heavy metals and metal alloys. To achieve such high Tg, extensive crosslinking is required, which usually tends to cause embrittlement.

Typically, high Tg will usually provide a high chemical resistance, but not with all chemicals. For example, acetone and methanol can disturb the crosslinked network (e.g., penetration of the matrix to the fibers).

Aromatic, cycloaliphatic, aliphatic, heterocyclic and polyether polyamines have been used in the past for the curing of epoxy resins. It is well known that aromatic amines provide better chemical resistance and thermal stability than cycloaliphatic and aliphatic or other polyamines. Several approaches have been considered to increase the glass transition temperature and chemical resistance of epoxy formulations. For structural applications it is desirable, particularly for reinforced composites, to produce an epoxy having a high Tg, improved chemical resistance, while maintaining the mechanical properties for overall composite performance. Although higher Tg can be achieved by formulating epoxy resins such as bisphenol-A (BPA), bisphenol-F (BPF) with epoxy novolac. The main drawback with this approach is a large increase in the viscosity of the formulation. High viscosity leads to processing challenges and increases flaws in the composite matrix due to the resin's very high viscosity. Numerous technical challenges exist to increasing the Tg and chemical resistance without sacrificing other properties.

Accelerators are generally known for use to accelerate curing agents which have very slow reactivity with epoxy resins (e.g., dicyanamide (DICY), anhydride, and aromatic amines). Epoxy resin systems are not generally known to be formulated to increase the Tg of liquid curing agent's epoxy system. Known epoxy systems having accelerator compounds included in the formulation are single component (1K) systems, typically found in adhesive and powder coating where they use the accelerator to increase the reactivity of amine in the latent epoxy system.

U.S. Pat. No. 5,512,372, which is hereby incorporated by reference in its entirety, discloses a hardenable, or polymerizable epoxy resin-based composition, characterized in that its hardener system comprises a combination in synergic quantities of at least one imidazole which, alone, can cause the polymerization of the epoxy resin only at a temperature above about 75° C. The U.S. Pat. No. 5,512,372 shows the use of imidazole as accelerator for one component polyamines, such as dicyanamide (DICY), and modified polyamine ANCAMINE® 2014 and does not disclose any thermal, mechanical or chemical resistance improvements. The U.S. Pat. No. 5,512,372 discloses one component systems and is specific to the latent curing agents. Further, the U.S. Pat. No. 5,512,372 only discloses a one component system having polyamine which is latent at room temperature for more than 21 days and none of the examples disclose amines that are active at room temperature with epoxy resins. The one component system disclosed in the U.S. Pat. No. 5,512,372 includes high loadings of imidazole and undesirably low Tg for the cured formulation. In addition, the U.S. Pat. No. 5,512,372 does not disclose compositional ranges that include off-stoichiometric ratios of curing agent to epoxy.

International Patent Application Publication WO2009/089145, which is hereby incorporated by reference in its entirety, discloses an epoxy resin mixture including cycloaliphatic epoxy resins, a cycloaliphatic anhydride hardener and a catalyst. WO2009/089145 further discloses adding two or more epoxy resins and a cycloaliphatic anhydride hardener to form a curable composition, wherein the epoxy resins include at least one cycloaliphatic epoxy resin and epoxy novolac resin; and thermally curing the composition at a temperature of at least 150° C. to result in a thermoset resin having a glass transition temp of at least 210° C. However, WO2009/089145 does not disclose any thermal, mechanical or chemical resistance improvements. The disclosure of WO2009/089145 illustrates a known approach to enhance the Tg of a mixture of epoxies (cycloaliphatic plus high functionality epoxy novolac resins) with cycloaliphatic anhydride and an accelerator. However, the WO2009/089145 does not disclose compositional ranges that include off-stoichiometric ratios of curing agent to epoxy. WO2009/089145 utilizes an anhydride curing agent, such as nadic methyl anhydride, which is known to provide higher Tg if cured using certain curing conditions. Multifunctional resin was used in WO2009/089145 to increase the Tg, but the mechanical properties disclosed using anhydride curing agent are undesirably low.

U.S. Pat. No. 4,540,750, which is hereby incorporated by reference in its entirety, discloses a method for making an adduct using diethyltoluenediamine (DETDA). The U.S. Pat. No. 4,540,750 discloses the DETDA as a polyamine curing agent. Since epoxy reactions with DETDA are very sluggish, the U.S. Pat. No. 4,540,750 discloses the use of an adduct to increase the reactivity of DETDA. In example A of this invention, 1-methyl imidazole (AMI-1) was used with DETDA adduct; however, the thermal properties, including Tg, resulting from the mixture were undesirably low compared to the examples without use of imidazole and did not disclose the effect on mechanical properties.

U.S. Pat. No. 4,528,308, which is hereby incorporated by reference in its entirety, discloses epoxy resin formulations, particularly curing agent formulations where large amounts of imidazole are used and polyetheramines were added to enhance the flexibility/toughness. 1-methyl imidazole (AMI-1) and 2-ethyl 4-methyl imidazole (EMI-24) are disclosed as being utilized at high loading in the formulation. The imidazole is used to initiate the cure of the epoxy resin and a very low amount of polyether amine is added back to the formulation to improve the flexibility (i.e. % elongation). In the U.S. Pat. No. 4,528,308, the imidazole is used as the primary reactant while the polyether amine is used as the secondary to improve the flexibility/toughness of the system. U.S. Pat. No. 4,528,308 does not disclose glass transition temperature or chemical resistance improvements.

U.S. Pat. No. 5,672,431, which is hereby incorporated by reference in its entirety, discloses epoxy resins and, more particularly, to epoxy resins incorporated with an imidazole accelerator in combination with chromium acetylaacetonate (Cr (acac)₃). The U.S. Pat. No. 5,672,431 discloses a solid amine hardener of 4,4′-diaminodiphenyl sulfone (DDS) with imidazole and tertafunctional resin. The resultant cured resin had an increased fracture toughness, but the glass transition temperature dropped significantly. The U.S. Pat. No. 5,672,431 discloses a multifunctional resin in combination with aromatic amine to achieve a higher fracture toughness and interlaminar shear properties, but with undesirably low strength and Tg.

Epoxy compositions, epoxy products and epoxy composite products having desirable physical, thermal and chemical properties not suffering from the above drawbacks would be desirable in the art. These needs are addressed by the embodiments of the present invention as described below and defined by the claims that follow.

### BRIEF SUMMARY OF THE INVENTION

One aspect of the present disclosure includes an epoxy resin composition having a curing component and an epoxy component. The curing component includes an amount of about 8% to about 70% by weight of the composition of a primary curing agent and about 0.001 to about 5% by weight of the composition of a secondary curing agent. The epoxy composition also includes about 30% to about 92% by weight of the epoxy component. A number of equivalents of reactive curative groups present in the curing component is from about 0.50 to 0.98 times a number of epoxide equivalents present in the epoxy component.

Another aspect of the present disclosure includes an epoxy product that includes the reaction product of an epoxy resin composition, the epoxy resin composition comprising a curing component and an epoxy component. The curing component includes about 8% to about 70% by weight of the composition of a primary curing agent and about 0.001 to about 5% by weight of the composition of a secondary curing agent. The epoxy component includes about 30% to about 92% by weight of the composition of an epoxy component. The epoxy resin composition includes a number of equivalents of reactive curative groups that are present in an amount in the curing component from about 0.50 to 0.98 times a number of epoxide equivalents that are present in the epoxy component.

Other features and advantages of the present invention will be apparent from the following more detailed description of the preferred embodiment, taken in conjunction with the accompanying drawings which illustrate, by way of example, the principles of the invention.

### DETAILED DESCRIPTION OF THE INVENTION

Provided are epoxy resin compositions, epoxy products and epoxy composite products having desirable thermal, physical and chemical properties. The epoxy resin compositions include an epoxy resin, a curing component that includes a primary curing agent, such as polyamine, and a secondary curing agent, such as imidazole, to enhance the thermal properties, chemical properties in various reagents, while maintaining the mechanical properties necessary for structural composite parts. In addition, the epoxy resin composition maintains the low viscosity and pot life of the formulation typically required for composite fabrication. The epoxy resin composition of the present disclosure is suitable to fabricate composite parts by filament winding, resin infusion, hand lay-up, vacuum assisted resin transfer process, pultrusion and prepreg. The specific parts such as pipes, fittings, tanks, high pressure vessels, wind blade, boat, composite tools and other structural composites for automotive and aerospace applications.

Another embodiment of the present disclosure includes fiber reinforced epoxy composites impregnated with an epoxy system and comprising a mixture of a primary curing agent and a secondary curing agent, e.g., an imidazole compound or tertiary amine, which results in improved fiber composite properties.

The resin composition of the present disclosure exhibits excellent thermal and chemical properties without altering the processing properties such as viscosity and pot life. For example, as a result of good fiber wetting properties, the epoxy resin composition provides an improvement in fiber matrix adhesion, inter-laminar shear strength (ILSS), by 10% or more.

Embodiments of the disclosure include epoxy products having a glass transition temperature (Tg) that is higher than known epoxy systems and can include Tg greater than about 175° C. with bi-functional epoxy. In addition, epoxy products, according to certain aspects of the invention, have chemical resistance greater than chemical resistance of known epoxy systems.

Embodiments of the disclosure include epoxy resin compositions that desirably utilize off-stoichiometry with the amine containing curing agent. Unlike in conventional systems having only one or a mixture of polyamines where all the components contain reactive sites, embodiments of the present disclosure include compositional ratios of components, including off-stoichiometric concentrations that can be used to vary the properties of the cured system. For example, in one embodiment, the epoxy resin compositions having off-stoichiometric compositional concentrations permit an amount of the curing agent composition that partially functions as reactive diluents, and results in systems with better flexibility, better appearance and also better adhesion and abrasion.

Embodiments of the disclosure include epoxy products having a pot life that is equal to or greater than the pot life of known two component epoxy resin systems. For example, the pot life of an epoxy product according to an embodiment of the present disclosure may have up to two times or more the pot life of an epoxy system that is used in stoichiometric ratios and does not include the secondary curing agents.

Embodiments of the disclosure include epoxy products having a glass transition temperature of from greater than about 40° C. to about 280° C. or more. Embodiments may include a glass transition temperature of the epoxy product greater than about 170° C. or greater than about 220° C. or greater than about 280° C.

The formulation provided in the present disclosure has a lower cost in use (CIU) than known epoxy systems and reduces or eliminates the need for the use of multifunctional resins which have higher viscosity and can cause processing problems, while maintaining the mechanical properties of the composite parts (e.g., improved inter laminar shear strength (ILSS)). In addition, low temperature cure and faster throughput make the product more attractive to many composite processing techniques. This approach allows us to tailor and balance the performance necessary for composite applications.

Embodiments of the disclosure include epoxy resin compositions that require a reduced amount of crosslinking curing component than known epoxy systems. In addition, the utilization of the combination of the primary curing agent and secondary curing agent, as disclosed, permits decreased processing time, and increases the process throughput.

The following definitions and abbreviations are provided in order to aid those skilled in the art in understanding the detailed description of the present invention.
AHEW—amine hydrogen equivalent weight
AMI-1—1-methyl imidazole
ANCAMINE® 2655—Aliphatic amine
ANCAMINE® 2264—Cycloaliphatic amine
ANCAMINE® DL50—Aromatic amine
DERTM 383—Liquid DGEBA with EEW approximately 178-184 (Functionality—1.8)
DERTM 438—Liquid novolac epoxy resin with EEW approximately 176-181 (Functionality—3.6)
DETDA—Diethyltoluene diamine
DICY—dicyanamide
DI Water—Deionized water
DGEBA—diglycidyl ether of bisphenol-A,
EEW—epoxy equivalent weight
EMI-24—2-ethyl 4-methyl imidazole
EPON® 826—liquid epoxy resin with EEW approximately 178-180
HNO₃—Nitric acid
ILSS—Inter Laminar Shear strength
IPDA—Isophorone diamine
JEFFAMINE® D230/D2000/T5000—poly(alkylene oxide) available from Huntsman Corp.
NaOH—Sodium hydroxide
PHR—parts per hundred weight resin
PACM—4,4′-methylenebiscyclohexanamine
Tg—Glass Transition temperature
1K—one component
2K—two components

Stoichiometric epoxy formulations include concentrations of curing agent added to epoxy in such an amount that for each epoxy group in the system there is one reactive hydrogen atom in the curing agent. The curing agents are generally added to the formulation in such an amount that there is one reactive hydrogen atom in the curing component for each epoxy group in the epoxy resin component. The stoichiometric quantity can be determined from, for example, the chemical structure and analytical data of the component. For example, imidazole provided as a secondary curing agent in the present formulation may not have reactive hydrogen to cure with an epoxy group. The secondary curing agent provides a catalytic effect on epoxy resin. In formulations according to the present disclosure, a primary curing agent is provided in an off-stoichiometric concentration with respect to an epoxy resin component and a controlled concentration of secondary curing agent is further added. The epoxy resin composition is cured, wherein the primary curing provides crosslinking of the epoxy component. While not wishing to be bound by theory, it is believed that the secondary curing agent provides a catalytic effect on the epoxy component, resulting in a certain degree of homopoloymerization, that in combination with the crosslinking of the primary curing agent providing a desirably high glass transition temperature without embrittlement, while maintaining structural performance and other properties. The combination of the primary curing agent and the secondary curing agent in controlled amounts according to the present disclosure results in the desirable combination of thermal properties and chemical properties in various reagents, while maintaining the mechanical properties necessary for structural composite parts.

The curing component includes a primary curing agent and a secondary curing agent. The primary curing agent is provided in an amount from about 8% to about 70% by weight of the composition (i.e., epoxy component+curing component), or about 15% to about 50% by weight of the composition. The primary amine can consist of a single amine, or it can be a mixture of amines.

In the epoxy resin composition according to certain embodiments of the disclosure, only the primary curing agent is considered to take part in the stoichiometric balance. The secondary curing agent does not contain labile hydrogen that takes part in the reaction and is generally not considered for the stoichiometric calculations. However, the secondary curing agent, although not having reactive groups, acts as a cross-linker through the effect of the tertiary amines, in the homopolymerization of the epoxy component. In this disclosure, the adjustment from the known stoichiometry is a balance of the amount of curing component to epoxy component to obtain a cured product having desirable properties. The adjustment is accomplished by providing an amount of the primary curing agent (e.g., cross-linker) to a corresponding amount of secondary curing agent (e.g., catalytical homopolymerization component), together leading to a full or near full conversion of all the epoxy groups to form the desired higher performance matrix.

The secondary curing agent is provided in an amount about 0.001 to about 5% by weight of the composition, or about 0.5 to about 2.5% by weight. The secondary curing agent would act as a catalyst with epoxy resin. According to certain embodiments of the present disclosure, a controlled amount of curing component is provided to balance the desired properties. For example, in one embodiment, the number of equivalents of reactive curative groups in the curing component is from about 0.50 to about 0.98 times or from about 0.70 to about 0.95 times the number of epoxide equivalents present in the epoxy component, with from about 0.80 times the number of epoxide equivalents present in the epoxy component to a stoichiometric amount being particularly preferred. The number of equivalents of reactive curative groups in the curing component can be readily determined by any known method for calculating the number of reactive curative groups. The exact amount of constituents in accordance with the above general requirements will depend on the application for which the cured resin is intended.

The epoxy component is from about 92% to 30% by weight of the epoxy resin composition, preferably between about 85% to 50% by weight. The epoxy resin can be a single resin, or it can be a mixture of mutually compatible epoxy resins.

While not wishing to be bound by theory, it is believed that the desirable combination of mechanical and chemical properties results from an interaction between crosslinking amines parts of the composition and the tertiary amines (imidazoles or others) that lead to homopolymerization reactions in the epoxy component. This interaction permits the reduction in stoichiometry, and results in improved thermal as well as the physical and, in certain embodiments, the chemical properties over conventional stoichiometric amine cured systems. While not wishing to be bound by theory, it is believed that the reactions are intermolecular and are coupled within the matrix.

The primary curing agent includes an amine. In certain embodiments of the present disclosure, the polyamine used includes polyamines selected from one or more of an aliphatic polyamine such as diethylenetriamine (DETA), triethylenetetramine (TETA), teraethylenepentamine (TEPA), pentaethylenehexamine (PEHA), hexamethylenediamine (HMDA), N-(2-aminoethyl)-1,3-propanediamine (N₃-Amine), N, N′-1,2-ethanediylbis-1,3-propanediamine (N₄-amine), or dipropylenetriamine; an arylaliphatic polyamine such as m-xylylenediamine (mXDA), or p-xylylenediamine; a cycloaliphatic polyamine such as 1,3-bisaminocyclohexylamine (1,3-BAC), isophorone diamine (IPDA), or 4,4′-methylenebiscyclohexanamine (PACM), 4,4′-Methylenebis-(2-methyl-cyclohexanamine); an aromatic polyamine such as m-phenylenediamine, diaminodiphenylmethane (DDM), or diaminodiphenylsulfone (DDS); a heterocyclic polyamine such as N-aminoethylpiperazine (NAEP), or 3,9-bis(3-aminopropyl)2,4,8,10-tetraoxaspiro (5,5)undecane; a polyalkoxypolyamine where the alkoxy group can be an oxyethylene, oxypropylene, oxy-1,2-butylene, oxy-1,4-butylene or co-polymers thereof such as 4,7-dioxadecane-1,10-diamine, 1-propanamine,3,3′-(oxybis(2,1-ethanediyloxy))bis(diaminopropylated diethylene glycol ANCAMINE® 1922A), poly(oxy(methyl-1,2-ethanediyl)), alpha-(2-aminomethylethyl) omega-(2-aminomethylethoxy) (JEFFAMINE® D 230, D-400), triethyleneglycoldiamine and oligomers (JEFFAMINE® XTJ-504, JEFFAMINE® XTJ-512), poly(oxy(methyl-1,2-ethanediyl)), alpha,alpha′-(oxydi-2,1-ethanediyl)bis(omega-(aminomethylethoxy)) (JEFFAMINE® XTJ-511), bis(3-aminopropyl)polytetrahydrofuran 350, bis(3-aminopropyl)polytetrahydrofuran 750, poly(oxy(methyl-1,2-ethanediyl)), a-hydro-w-(2-aminomethylethoxy)ether with 2-ethyl-2-(hydroxymethyl)-1,3-propanediol (3:1) (JEFFAMINE® T-403), and diaminopropyl dipropylene glycol. JEFFAMINE® is a registered trademark of Huntsman Petrochemical LLC.

Particularly suitable polyamines include polyamines selected from diethylenetriamine (DETA), triethylenetetramine (TETA), 1,3-bisaminocyclohexylamine (1,3-BAC), isophoronediamine (IPDA), 4,4′-methylenebiscyclohexanamine (PACM), 3,3′Dimethyl PACM (ANCAMINE® 2049), N-aminoethylpiperazine (NAEP), 4,7-dioxadecane-1,10-diamine,l-propanamine,3,3′-(oxybis(2,1-ethanediyloxy))bis- (ANCAMI NE® 1922A), poly(oxy(methyl-1,2-ethanediyl)),alpha-(2-aminomethylethyl)omega-(2-aminomethylethoxy (JEFFAMINE® D 230, D-400), triethylene glycol diamine (JEFFAMINE® XTJ-504), and poly(oxy(methyl-1,2-ethanediyl))alpha,alpha′-(oxy(di-2,1-ethanediyl))bis(omega-(aminomethylethoxy)). (JEFFAMINE® XTJ-511) or mixture thereof. ANCAMINE® is a registered trademark of Air Products and Chemicals, Inc.

Additional amines suitable for forming the selectively modified amine are polyamines comprising at least one or more multifunctional amine having the following structure:

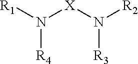

where R₁ is CH₂CH₂CH₂NH₂; R₂, R₃ and R₄ independently are H or CH₂CH₂CH₂NH₂; and X is CH₂CH₂ or CH₂CH₂CH₂. In one embodiment R₂ and R₃ are not H simultaneously.

In one embodiment, the secondary curing agent includes an imidazole. One embodiment includes a substituted imidazole and may be selected from one or more of 1-methyl imidazole, 2-methyl imidazole, 2-alkyl imidazole where the alkyl group can be an alkyl with 10 to 18 carbon atoms, 2-ethyl-4-methyl imidazole, 2-phenyl imidazole and 1-phenyl-2-methyl imidazole, 2-heptadecylimidazole, 1-cyanoethyl-2-phenylimidazole-trimellitate, 2-(β-(2′-methylimidazoyl-(1)))-ethyl-4-6-diamino-s-triazine, 2,4-dimethylimidazole 2-undecylimidazole, 2-heptadecenyl-4-methylimidazole, 2-heptadecylimidazole, 2-phenyl-4-methylimidazole, 1-benzyl-2-methylimidazole, 2-ethylimidazole, 2-isopropylimidazole, 2-phenyl-4-benzylimidazole, 2-vinylimidazole, 1-vinyl-2-methylimidazole, 1-propyl-2-methylimidazole, 1-(3-aminopropyl)-imidazole, butylimidazole 1-cyanoethyl-2-methylimidazole, 1-cyanoethyl-2-ethyl-4-methylimidazole, 1-cyanoethyl-2-undecylimidazole, 1-guanaminoethyl-2-methylimidazole, 1-cyanoethyl-2-isopropylimidazole, 1-cyanoethyl-2-phenylimidazole, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole, 2-methyl-4,5-diphenylimidazole, 2,3,5-triphenylimidazole, 2-styrylimidazole, 1-(dodecyl benzyl)-2-methylimidazole, 2-(2-hydroxyl-4-t-butylphenyl)-4,5-diphenylimidazole, 2-(2-methoxyphenyl)-4,5-diphenylimidazole, 2-(3-hydroxyphenyl)-4,5-diphenylimidazole, 2-(p-dimethyl-aminophenyl)-4,5-diphenylimidazole, 2-(2-hydroxyphenyl)-4,5-diphenylimidazole, di(4,5-diphenyl-2-imidazole)-benzene-1,4,2-naphthyl-4,5-diphenylimidazole, 1-benzyl-2-methylimidazole, and 2-p-methoxystyrylimidazole.

In one embodiment, the secondary curing agent may include tertiary amines. Illustrative suitable tertiary amines are selected from methyldiethanolamine, triethaniamine, diethylamionpropylamine, benzyldimethyl amine, m-xylylenedi(dimethylamine), N,N′-dimethylpiperazine, N-methylpyrrolidine, N-methyl hydrocypiperidine, N,N,N′N′-trtramethyldiaminoethane, N,N,N′,N′,N′-pentamethyldiethylenetriamine, tributyl amine, trimethyl amine, diethyldecyl amine, triethylene diamine, N-methyl morpholine, N,N,N′N′-tetramethyl propane diamine, N-methyl piperidine, N,N′-dimethyl-1,3-(4-piperidino)propane, Pyridine and the like. Other tertiary amines include 1,8-dizaobicyclo[5.4.0]undec-7-ene, 1,8-diazobicyclo[2.2.2]octane, 4-dimethylaminopyridine, 4-(N-pyrrolidino)pyridine, triethyl amine and 2,4,6-tris(dimethylaminomethyl)phenol, and combinations thereof.

The epoxy component includes an epoxy resin. The epoxy components may include about 30% to about 92% by weight of the composition, or between about 50% to about 85% by weight of the composition. The epoxy resin can consist of a single resin, or it can be a mixture of mutually compatible epoxy resins.

The epoxy resin may include, but is not limited to, bi-functional epoxies, such as, bisphenol-A and bisphenol-F resins. Multifunctional epoxy resin, as utilized herein, describes compounds containing two or more 1,2-epoxy groups per molecule. Epoxide compounds of this type are well known to those of skill in the art and are described in Y. Tanaka, “Synthesis and Characteristics of Epoxides”, in C. A. May, ed., Epoxy Resins Chemistry and Technology (Marcel Dekker, 1988), which is incorporated herein by reference in its entirety.

One class of epoxy resins suitable for use in the present disclosure comprises the glycidyl ethers of polyhydric phenols, including the glycidyl ethers of dihydric phenols. Illustrative examples include, but are not limited to, the glycidyl ethers of resorcinol, hydroquinone, bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane (commercially known as bisphenol A), bis-(4-hydroxyphenyl)-methane (commercially known as bisphenol-F, and which may contain varying amounts of 2-hydroxyphenyl isomers), and the like, or any combination thereof. Additionally, advanced dihydric phenols of the following structure also are useful in the present disclosure:

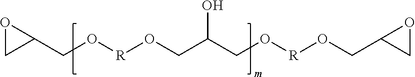

where m is an integer, and R is a divalent hydrocarbon radical of a dihydric phenol, such as those dihydric phenols listed above. Materials according to this formula can be prepared by polymerizing mixtures of a dihydric phenol and epichlorohydrin, or by advancing a mixture of a diglycidyl ether of the dihydric phenol and the dihydric phenol. While in any given molecule the value of m is an integer, the materials are invariably mixtures which can be characterized by an average value of m which is not necessarily a whole number. Polymeric materials with an average value of m between 0 and about 7 can be used in one aspect of the present disclosure. In other embodiments, the epoxy component may be a polyglycidyl amine from one or more of 2,2′-methylene dianiline, m-xylene dianiline, hydantoin, and isocyanate.

The epoxy component may be a cycloaliphatic (alicyclic) epoxide. Examples of suitable cycloaliphatic epoxides include diepoxides of cycloaliphaitc esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, vinylyclohexene diepoxides; limonene diepoxide; bis(3,4-epoxycyclohexylmethyl)pimelate; dicyclopentadiene diepoxide; and other suitable cycloaliphatic epoxides. Other suitable diepoxides of cycloaliphatic esters of dicarboxylic acids are described, for example, in Patent No. WO 2009/089145 A1, which is hereby incorporated by reference in its entirety.

Other cycloaliphatic epoxides include 3,3-epoxycyclohexylmethyl-3,4-epoxycyclohexane carboxylate such as 3,4-epoxycyclohexylmethyl-3,4-epoxycyclohexane carboxylate; 3,3-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexyl-methyl-3,4-epoxy-3-methylcyclohexane carboxylate. Other suitable 3,4-epoxycyclohexylmentyl-3,4-epoxycyclohexane carboxylates are described, for example, in U.S. Pat. No. 2,890,194, which is hereby incorporated by reference in its entirety. In other embodiments, the epoxy component may include polyol polyglycidyl ether from polyethylene glycol, polypropylene glycol or polytetrahydrofuran or combinations thereof.

In another aspect, epoxy novolac resins, which are the glycidyl ethers of novolac resins, can be used as multifunctional epoxy resins in accordance with the present disclosure. In yet another aspect, the at least one multifunctional epoxy resin is a diglycidyl ether of bisphenol-A (DGEBA), an advanced or higher molecular weight version of DGEBA, a diglycidyl ether of bisphenol-F, an epoxy novolac resin, or any combination thereof. Higher molecular weight versions or derivatives of DGEBA are prepared by the advancement process, where excess DGEBA is reacted with bisphenol-A to yield epoxy terminated products. The epoxy equivalent weights (EEW) for such products range from about 450 to 3000 or more. Because these products are solid at room temperature, they are often referred to as solid epoxy resins.

DGEBA or advanced DGEBA resins are often used for structural formulations due to a combination of their low cost and generally high performance properties. Commercial grades of DGEBA having an EEW ranging from about 174 to about 250, and more commonly from about 185 to about 195, are readily available. At these low molecular weights, the epoxy resins are liquids and are often referred to as liquid epoxy resins. It is understood by those skilled in the art that most grades of liquid epoxy resin are slightly polymeric, since pure DGEBA has an EEW of 174. Resins with EEW's between 250 and 450, also generally prepared by the advancement process, are referred to as semi-solid epoxy resins because they are a mixture of solid and liquid at room temperature. Generally, multifunctional resins with EEW's based on solids of about 160 to about 750 are useful in the present disclosure. In another aspect, the multifunctional epoxy resin has an EEW in a range from about 170 to about 250.

Depending upon the end-use application, it can be beneficial to reduce the viscosity of the compositions of the present disclosure by modifying the epoxy component. The epoxy component, which comprises at least one multifunctional epoxy resin, further comprises a monofunctional epoxide. Examples of monoepoxides include, but are not limited to, styrene oxide, cyclohexene oxide and the glycidyl ethers of phenol, cresols, tert-butylphenol, other alkyl phenols, butanol, 2-ethylhexanol, C₄ to C₁₄ alcohols, and the like, or combinations thereof. The multifunctional epoxy resin can also be present in a solution or emulsion, with the diluent being water, an organic solvent, or a mixture thereof.

According to certain embodiments, the epoxy system formulation for the composite may include additives, such as, but not limited to, non-reactive plasticizer(s), filler(s), processing aid(s), stabilizer, air release agent, viscosity modifier(s), UV absorbent agent, a flame retardant, and/or an impact modifier.

Nanomaterials are generally used as secondary reinforcement to enhance the thermal, mechanical and chemical properties of matrix resin. Nanomaterials, as utilized herein, include materials, wherein the individual particles or subcomponents of the nanomaterial have at least one dimension 100 nanometers or less. Nanomaterials, include, but are not limited to, multi-wall carbon or boron nitride nanotubes, single-wall carbon, carbon or boron nitride nanopartices, carbon or boron nitride nanofibers, carbon or boron nitride nanoropes, carbon or boron nitride nanoribbons, nanoclays; nanoclays comprising tubules; layered inorganic clay material; talc; carbon black; cellulose fibers; silica; and alumina.

One embodiment of the present disclosure includes an epoxy composite. To form an epoxy composite, the epoxy resin composition includes reinforcing fibers. Reinforcing fibers for the fiber composite of the present disclosure may include customary fibers which are used for fiber reinforcement of materials. Suitable reinforcing fibers include organic or inorganic fibers, natural fibers or synthetic fibers, and may be present in the form of wovens or non-crimp fabrics, nonwoven webs or mats, and also in the form of fiber stands (rovings), or staple fiber formed of continuous or discontinuous fiber such as fiberglass, E glass fiber, S glass fiber, S-2 GLASS®, fiber or C glass, fiber, silicon carbide or disilicon carbide containing titanium fiber, carbon/graphite fiber, boron fiber, quartz, aluminium oxide, carbon nanotubes, nano composite fibers, polyaramide fibers such as those sold under the trade name KEVLAR®, Poly(p-phenylene benzobisoxazole) fiber such as those sold under the trade name ZYLON®, ultrahigh molecular weight polyethylene fibers such as those sold under the trade name SPECTRA®, high and low density polyethylene fibers, polypropylene fibers, nylon fibers, cellulose fibers, natural fibers, biodegradable fibers and combinations thereof. Other suitable fibers include silicon carbide fiber, such as NICALON™ from Nippon Carbon Company; and Silicon carbide fibers containing titanium, such as TYRRANO™ from Ube America, Inc. S-2 GLASS® is a registered trademark of AGY Holding Corp. KEVLAR® is a registered trademark of E.I. du Pont de Nemours and Company. ZYLON® is a registered trademark of Toyo Boseki Kabushiki Kaisha, Ta Toyobo Co., Ltd. SPECTRA® is a registered trademark of Honeywell International Inc.

These fibers (wovens or non-wovens) can be coated with the solvent or solvent free epoxy resin mixture by the standard impregnating methods, in particular for filament winding, pultrusion, sheet molding compound, bulk molding compound autoclave molding, resin infusion, vacuum assisted resin transfer molding, hand lay-up, resin impregnation, prepreg, compression molding, brushing, spraying, or dipping, casting, injection molding or combination thereof.

Mixing of the curing component and the epoxy component to form the epoxy resin composition can be in any order and by any appropriate means known in the art for two component epoxy compositions. The mixing may be accomplished according to any known method for mixing, including, but not limited to, mixing by magnetic stirrers, high shear mixing, hand mixing, mechanical mixing or other suitable mixing method. The mixing of the curing component is preferably carried out at a temperature in the range of 0° to 150° C., preferably 30° to 60° C.

The curable epoxy resin compositions and cured products described herein may be useful as adhesives, structural and electrical laminates, coating, casting, structural components for aerospace industries, and as circuit boards and the like for the electronics industry, among other applications. The curable epoxy resin compositions disclosed herein may also be used in electrical varnishes, encapsulants, semiconductors, general molding powders, filament wound pipe, storage tanks, liners for pumps, and corrosion resistant coatings, and other suitable epoxy containing products.

### EXAMPLES

### Example 1

Preparation of compositions. Primary curing agent (cycloaliphatic amine) compositions were formulated with various secondary curing agents (imidazoles) to make the liquid curing component used according to this disclosure.

TABLE 1

| | | Secondary | | Secondary | |
|---|---|---|---|---|---|
| | Primary | Curing | | Curing | Final form |
| Formu- | Curing | Agent | Mixing | Agent | after 30 |
| lation | Agent | Imidazole | temp ° C. | solubility | days |
| 1 | PACM | 0 | 0 | NA | Liquid |
| 2 | PACM | AMI-1 | 50 | Completely | Liquid |
| | | | | soluble | |
| 3 | PACM | AMI-2 | 100 | Partially | hazy liquid |
| | | | | soluble | |
| 4 | PACM | EMI-24 | 50 | Competently | Liquid |
| | | | | soluble | |
| 5 | PACM | 2MZ Amize | 100 | Partially | Hazy liquid |
| | | | | Soluble | |

In Table 1, 4,4′-methylenebiscyclohexanamine (PACM) was used as a primary amine and mixed with various accelerators which were added to determine their solubility in that PACM. It is desirable to use formulated curing agents in a liquid form for composite applications. Commercial imidazoles are either sold in a liquid or solid form. The solubility of liquid accelerators was very good in PACM that means liquid accelerators will have good compatibility with amines. With solid accelerators the solubility will depend on the polyamine used. Certain solid imidazoles are partially soluble.

### Example 2

Several curing agent formulations were prepared. PACM was used as a primary curing agent and 1-methyl imidazole (AMI-1) was utilized as secondary curing agent. Both products were mixed in the amount shown in Table 2. To facilitate mixing, both the PACM and the AMI-1 were preheated separately at 50° C. for 1 hour. Formulations 1-9 were mixed with magnetic stirrer at 1000 rpm at 50° C. for 1 hour. Resulting formulations were used to cure epoxy resin (epoxy equivalent weight (EEW) 180) at varied stoichiometric ratios. A small percent of polyether amines were also considered in some formulations (Formulations 6 and 9) to analyze the effect on thermal and impact properties.

Formulations 1-3 are comparative examples wherein Formulation 1 is liquid epoxy resin (LER) (EEW 180) with PACM and Formulations 2 and 3 are 80:20 and 70:30 mixture of EPON® 826: DER 438, respectively. EPON® is a registered trademark of Hexion Specialty Chemicals, Inc.

The epoxy component and amine curatives described above were hand mixed at 40° C. for 3-5 minutes. Entrapped air was removed by placing the mixture in a centrifuge for 5 minutes or until the mixture was clear. The mixture was then poured into a ⅛″ aluminum mold. The system in the mold was cured at 80° C. for 2 hours plus 150° C. for 3 hours. Molds were allowed to cool to room temperature before removing the cured sample. Specimens were prepared from the cast samples according to ASTM methods to perform the mechanical testing; tensile test (ASTM D638), flexural test (ASTM D790), Izod impact (ASTM 256) and compressive (ASTM D695). Additional 1″×3″×⅛″ samples were prepared to perform chemical resistance testing in different reagents.

The reactivity of all formulations shown in Example 2 were measured at 60° C. using Brookfield viscometer RV with spindle number 27. 12 grams of epoxy resin composition were used to measure the reactivity.

A TECHNE® gel timer was used to measure the gel time of all the formulation shown in Example 2. The one end of the metal rod was connected to the TECHNE® gel timer and another end with the 1″ diameter dish. The epoxy component and curing agents were preheated separately at 25° C. A total of 150 grams of mixture (epoxy component and curing components) was mixed for 3-5 minutes. The 1″ diameter dish was immersed into the beaker content mixture and Gel time was turned ON immediately to obtain an accurate reading.

TABLE 2
Table 2: Curing agent formulation with AMI-1

| Formulation | 1 | 2 | 3 | 4 |
|---|---|---|---|---|
| PACM | 100 | 100 | 100 | 99 |
| AMI-1 | — | — | — | 1 |
| D2000 | — | — | — | — |
| T5000 | — | — | — | — |
| LER EEW-180 | 100 | 80 | 70 | 100 |
| DER 438 | — | 20 | 30 | |
| Phr used | 29 | 29 | 29 | 24 |
| Tg C. (ISO) | 160 | 167 | 175 | 163 |
| Gel time @ 25 C. | 214 | 144 | 125 | 215 |
| Time to 10,000 | 94 | 74 | 66 | 93 |
| cps @ 40 C. | | | | |
| Mix vis @25 C. | 517 | 715 | 831 | 527 |
| with EEW180 | | | | |
| Mechanical | | | | |
| Properties | | | | |
| Tensile | 9,726 | 8,146 | 8,658 | 9,500 |
| Strength(psi) | | | | |
| Tensile | 251,000 | 297,000 | 304,000 | 257,000 |
| Modulus (psi) | | | | |
| % Elongation | 5.5 | 4.3 | 4.7 | 5.0 |
| Flexural | 17,700 | 15,883 | 17,658 | 15,487 |
| Strength (psi) | | | | |
| Flexural | 276,000 | 250,000 | 270,000 | 275,000 |
| Modulus(psi) | | | | |
| Izod Impact | 560 | 511 | 452 | 500 |
| (unnotch) | | | | |
| Comp Strength (psi) | 15,425 | 9,895 | 10,302 | 15,323 |
| Comp Modulus (psi) | 275,000 | 129,000 | 255,093 | 273,000 |

| Formulation | 5 | 6 | 7 | 8 | 9 |
|---|---|---|---|---|---|
| PACM | 98.5 | 93.5 | 98.5 | 98 | 93.5 |
| AMI-1 | 1.5 | 1.5 | 1.5 | 2 | 1.5 |
| D2000 | — | 2.5 | — | — | 2.5 |
| T5000 | — | 2.5 | — | — | 2.5 |
| LER EEW-180 | 100 | 100 | 100 | 100 | 100 |
| DER 438 | | | | | |
| Phr used | 24 | 24 | 26 | 26 | 26 |
| Tg C. (ISO) | 174 | 173 | 169 | 156 | 170 |
| Gel time @ 25 C. | 213 | 217 | 214 | 213 | 214 |
| Time to 10,000 | 94 | 94 | 95 | 95 | 96 |
| cps @ 40 C. | | | | | |
| Mix vis @25 C. | 525 | 580 | 510 | 503 | 565 |
| with EEW180 | | | | | |
| Mechanical | | | | | |
| Properties | | | | | |
| Tensile | 9,022 | 10,275 | 9,359 | 9,245 | 9,576 |
| Strength(psi) | | | | | |
| Tensile | 265,000 | 263,950 | 272,000 | 277,000 | 268,000 |
| Modulus (psi) | | | | | |
| % Elongation | 5.2 | 6.0 | 5.6 | 4.8 | 6.0 |
| Flexural | 16,828 | 17,500 | 18,050 | 17,486 | 15,876 |
| Strength (psi) | | | | | |
| Flexural | 281,000 | 275,000 | 274,000 | 287,000 | 277,853 |
| Modulus(psi) | | | | | |
| Izod Impact | 486 | 585 | 527 | 550 | 569 |
| (unnotch) | | | | | |
| Comp Strength (psi) | 16,214 | 16,846 | 15,960 | 15,500 | 15,329 |
| Comp Modulus (psi) | 287,000 | 283,600 | 275,000 | 269,000 | 271,873 |

A conventional approach to boost the Tg of the bi-functional resin is shown in the comparative Formulations 2 and 3, a multifunctional novolac epoxy resin (functionality 3.6) blended with bi-functional epoxy (functionality 1.9). Formulations 2 and 3, as shown in Table 2, resulted in adversely affected viscosity, pot life and at least some of the mechanical properties of the systems.

The results for Formulations 1-9 are reported in Table 2. Formulations 4-9, according to the present disclosure, included a maintained viscosity and pot life of the systems. Formulation 5 provides a Tg that approximates the comparative Formulations 2 and 3 corresponding to a conventional formulation. The tensile strength and elongation were improved or maintained for Formulation 5. Formulation 6 overcomes the undesirable brittleness of Formulations 1 to 3. As shown in Table 2, elongation and impact resistance improved in Formulations 4-9, while maintaining the thermal properties. Lower modulus value for Formulation 6 and 9 generally indicates the systems are less brittle.

### Example 3

A similar approach to Example 2 was utilized in Example 3 but with a 2-ethyl 4-methyl imidazole (EMI-24) as secondary curing agent. The results are reported in Table 3. Formulation 10, which contains 2 parts of EMI-24, provides a desirable Tg at 171° C. In Examples 11 and 13, longer chain polyether amines poly(alkylene oxide) were added to the formulation to modify the structural performance, which resulted in little or no alteration of the thermal properties.

TABLE 3
Table 3 Curing agent formulation with EMI-24

| Formulation | 1 | 2 | 3 | 10 | 11 | 12 | 13 |
|---|---|---|---|---|---|---|---|
| PACM | 100 | 100 | 100 | 98 | 93 | 98 | 94 |
| EMI-24 | — | — | — | 2 | 2 | 2 | 1 |
| D2000 | — | — | — | — | 2.5 | | 2.5 |
| T5000 | — | — | — | — | 2.5 | | 2.5 |
| LER EEW-180 | 100 | 80 | 70 | 100 | 100 | 100 | 100 |
| DER 438 | — | 20 | 30 | | | | |
| Phr | 29 | 29 | 29 | 24 | 24 | 26 | 26 |
| Tg C. (ISO) | 160 | 167 | 175 | 171 | 172 | 167 | 170 |
| Gel time @ 25 C. | 214 | 144 | 125 | 185 | 196 | 194 | 197 |
| (150 gms mass) | | | | | | | |
| Time to 10,000 cps @ | 94 | 74 | 66 | 94 | 95 | 94 | 96 |
| 40 C. | | | | | | | |
| Mix vis @25 C. with | 517 | 715 | 831 | 587 | 595 | 539 | 567 |
| EEW180 | | | | | | | |
| Mechanical Properties | | | | | | | |
| Tensile Strength(psi) | 9,726 | 8,146 | 8,658 | 7,863 | 9,853 | 9,197 | 9,525 |
| Tensile Modulus (psi) | 251,000 | 297,000 | 304,000 | 290,000 | 287,000 | 276,000 | 282,354 |
| % Elongation | 5.5 | 4.3 | 4.7 | 4.3 | 5.8 | 5.4 | 5.5 |
| Flexural Strength (psi) | 17,700 | 15,883 | 17,658 | 17,826 | 17,645 | 17,542 | 17,242 |
| Flexural Modulus(psi) | 276,000 | 250,000 | 270,000 | 270,000 | 280,564 | 264,000 | 283,457 |
| Izod Impact (unnotch) | 560 | 511 | 452 | 337 | 577 | 528 | 567 |
| Comp Strength (psi) | 15,425 | 9,895 | 10,302 | 16,776 | 15,896 | 16,199 | 16,102 |
| Comp Modulus (psi) | 275,000 | 129,000 | 255,093 | 265,000 | 277,290 | 262,000 | 275,154 |

### Example 4

Example 4 utilized different classes of curing agent chemistry including cycloaliphatic diamine with aliphatic diamine, a mixture of aromatic diamines and cycloaliphatic diamine mixture.

As shown in Table 4, high thermal properties are achieved in Formulations 14-16 without modifying the resin chemistry. This helps the easy handling of the resins on the manufacturing site.

TABLE 4
Table 4: Curing agents mixture with AMI-1

| Formulation | 14 | 15 | 16 |
|---|---|---|---|
| PACM | 89 | — | 13 |
| ANCAMINE ® 2655 | 10 | — | — |
| DL50 | — | 79 | — |
| DETDA | — | 20 | 17 |
| ANCAMINE ® 2264 | — | — | 40 |
| IPDA | — | — | 30 |
| AMI-1 | 1 | 1 | 1.25 |
| LER EEW-180 | 100 | 100 | 70 |
| Phr | 24 | 24 | 24 |
| Tg C. (ISO) | 163 | 175 | 168 |
| Gel time @ 25 C. | 135 | — | 180 |
| (150 gms mass) | | | |
| Mechanical Properties | | | |
| Tensile Strength(psi) | 10,346 | 10,090 | 9,150 |
| Tensile Modulus (psi) | 249,000 | 277,000 | 310,000 |
| % Elongation | 5.6 | 5.8 | 7.0 |
| Flexural Strength (psi) | 19,040 | 17,673 | 19,500 |
| Flexural Modulus(psi) | 392,000 | 295,000 | 337,000 |
| Comp Strength (psi) | 16,254 | 19,160 | 16,228 |
| Comp Modulus (psi) | 224,000 | 225,000 | 303,000 |

### Example 5

TABLE 5

| Formulation | 17 | 18 | 19 | 20 | 21 | 22 |
|---|---|---|---|---|---|---|
| IPDA | 100 | 99 | 98 | — | — | — |
| D230 | — | — | — | 100 | 99 | 98 |
| TETA | — | — | — | — | — | — |
| A502 | — | — | — | — | — | — |
| AMI-1 | — | 1 | 2 | — | 1 | 2 |
| LER | 100 | 100 | 100 | 100 | 100 | 100 |
| Phr | 24 | 20 | 20 | 33 | 26 | 26 |
| Tg ° C. (ISO-60 C. | — | 150 | 151 | 97 | 97 | 104 |
| for 2 hrs + | | | | | | |
| 125 C. for 3 hrs) | | | | | | |
| Second Scan Tg ° C. | 148 | 158 | 162 | 100 | 97 | 104 |

| Formulation | 23 | 24 | 25 | 26 | 27 | 28 | 29 |
|---|---|---|---|---|---|---|---|
| IPDA | — | — | | — | — | — | — |
| D230 | — | — | | — | — | — | — |
| TETA | 100 | 99 | 98 | — | — | — | — |
| A502 | — | — | — | 100 | 100 | 99 | 98 |
| AMI-1 | — | 1 | 2 | — | 1 | 1 | 2 |
| LER | 100 | 100 | 100 | 100 | 100 | 100 | 100 |
| Phr | 17 | 14 | 14 | 50 | 50 | 42 | 42 |
| Tg ° C. (ISO-60 C. | 130 | 142 | 144 | 78 | 75 | 84 | 92 |
| for 2 hrs + | | | | | | | |
| 125 C. for 3 hrs) | | | | | | | |
| Second Scan Tg ° C. | 130 | 142 | 144 | 78 | 80 | 85 | 92 |

Example 5 includes various curing agent chemistries. Formulations 17, 20, 23 and 26 are the control formulations, typically used in correct stoichiometry. The corresponding formulations are with imidazole with under stoichiometry of amine to epoxy. The results shown in Table 5 show all the formulation examples according to the present disclosure that contain imidazole and have enhanced glass transition temperature compared to the non-imidazole containing formulation.

### Example 6

Chemical resistance properties of the Formulations 1-3,5,6,10 and 11 are shown in Table 6. For all these formulations specimens were prepared in size (1 inch×3 inch×⅛ inch) from a cast of 8 inch×8 inch×⅛ inch. Specimens were immersed into different reagents (acid, base and solvent) at 104° F. (40° C.) for a period of 600 hrs.

TABLE 6
Table 6: Chemical resistance of formulated
amine in various reagents

| | % weight gain after 600 hrs | | | | | | |
|---|---|---|---|---|---|---|---|
| Formulation | 1 | 2 | 3 | 5 | 6 | 10 | 11 |
| 20% HNO₃ | 4.8 | 5 | 7 | 5.1 | 4.6 | 5.3 | 4.6 |
| (aqueous) | | | | | | | |
| 20% NaOH | 6 | 5.5 | 6.2 | 4.8 | 5.3 | 4.5 | 5.5 |
| (aqueous) | | | | | | | |
| Acetone | 7.3 | 5.0 | 7.17 | 6.2 | 5.3 | 5.5 | 5.8 |
| DI water | 1.6 | 2.0 | 1.57 | 1.4 | 1.6 | 1.5 | 1.7 |

The visual inspection on specimens does not show etching, cracking or blistering effects on cast samples. This indicates that the percent weight gain was proportional to the amount of chemical absorbed by the cast specimens. The formulation utilized for formulations according to the present disclosure showed superior chemical resistance compared to the Comparative Formulations 1-3.

### Example 7

Composite panels are fabricated using Vacuum Assisted Resin Transfer Molding (VARTM). The metal mold was prepared by coating the entire mold inner surface with SEALER GP™ and followed by ENVIROSHIELD™ non-hazardous release agent from Zyvax to avoid sticking of epoxy formulation to the aluminum surface.

The mold was heated at 45° C. for 30 minutes to ensure the release agent was completely dried before stacking the glass fabric. Mold plates are machined to produce 6 inch×6 inch×⅛ inch (length×width×depth) composite panels. Twelve layers of unidirectional fiberglass (275 gram/meter²) were carefully stacked into the mold cavity without fabric overlap and wrinkle in each layer. The top half of the mold was then closed. Heating was continued at 45° C. A rotary vacuum pump is used to evacuate the system down to ˜15 psi or 29 inch Hg vacuum and was maintained.

The Formulations shown in Example 1 were hand mixed at 40° C. for 3-5 minutes. Entrapped air was removed by placing the mixture in a centrifuge for 5 minutes or until the mixture was cleared. The mold inlet tube was placed into the mixture. The PVC ball valve was gently opened to let mixture flow through the tube to infuse through the fiberglass plies layered within a closed aluminum mold. Fibers are infused with resin until most of the pre-weighed mixture is consumed from the beaker. Excess resin is collected in a catch pot. Integrated rod heaters allow the mold to be pre-warmed during infusion (40-60° C.) that allows uniform flow of resin in the mold for better fiber wetting.

The mold was heated to higher temperatures (80° C. for 2 hours+150° C. for 3 hours) for post-curing. After finishing the cure schedule, the mold was cooled down to room temperature to remove the composite panel.

TABLE 7
Fabrication method: Vacuum Assisted Resin Transfer Molding (VARTM)

| | Mechanical Properties unidirectional composites | | | | |
|---|---|---|---|---|---|
| | Formulation | | | | |
| Mechanical Properties | 1 | 5 | 6 | 15 | 16 |
| Flexural Strength (psi) | 153,177 | 164,349 | 164,214 | 174,502 | 166,311 |
| Flexural Modulus(psi) | 6,773,000 | 7,071,000 | 6,630,000 | 7,105,000 | 6,807,000 |
| ILSS (psi) 0 hrs | 8,448 | 9,724 | 10,636 | 10,000 | 9,650 |

Fiber type: E-glass (275 g/m2) unidirectional
Fiber volume: 60+3%
Cure schedule: 1 hr @180° C.+3 hrs @ 150° C.

The mechanical properties; flexural strength, modulus and interlaminar shear strength were improved by the formulation approach used for the present disclosure.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An epoxy resin composition comprising:
a curing component, the curing component comprising:
about 8% to about 70% by weight of the composition of a primary curing agent; and
about 0.001% to about 5% by weight of the composition of a secondary curing agent; and
about 30% to about 92% by weight of the composition of an epoxy component;
wherein a number of equivalents of reactive curative groups in the curing component is from about 0.50 to 0.98 times a number of epoxide equivalents present in the epoxy component.

2. The epoxy resin composition of claim 1, wherein the number of equivalents of reactive curative groups in the curing component is from about 0.70 to 0.95 times a number of epoxide equivalents present in the epoxy component.

3. The epoxy resin composition of claim 1, wherein the number of equivalents of reactive curative groups in the curing component is about 0.80 times a number of epoxide equivalents present in the epoxy component.

4. The epoxy resin composition of claim 1, wherein the primary curing component is present in an amount from about 15% to about 50% by weight of the composition.

5. The epoxy resin composition of claim 1, wherein the secondary curing component is present in an amount from about 0.5% to about 2.5% by weight of the composition.

6. The epoxy resin composition of claim 1, further comprising a reinforcing fiber.

7. The epoxy resin composition of claim 6, wherein the reinforcing fiber is selected from the group consisting of woven or non-crimp fabrics, nonwoven webs or mats, fiber stands, staple fiber formed of continuous or discontinuous fiber and combinations thereof.

8. The epoxy resin composition of claim 6, wherein the reinforcing fiber is selected from the group consisting of fiberglass, carbon fiber, carbon nanotubes nano composite fibers, polyaramide fibers, poly(p-phenylene benzobisoxazole) fiber, ultrahigh molecular weight polyethylene fibers, high and low density polyethylene fibers, polypropylene fibers, nylon fibers, cellulose fibers, natural fibers, biodegradable fibers and combinations thereof.

9. The epoxy resin composition of claim 1, wherein the primary curing agent is selected from the group consisting of aliphatic polyamine, arylaliphatic polyamine, cycloaliphatic polyamine, aromatic polyamine, heterocyclic polyamine polyalkoxypolyamine, where the alkoxy group is an oxyethylene, oxypropylene, oxy-1,2-butylene, oxy-1,4-butylene or co-polymer thereof and combinations thereof.

10. The epoxy resin composition of claim 1, wherein the primary curing agent is selected from the group consisting of diethylenetriamine, triethylenetetramine, teraethylenepentamine, pentaethylenehexamine, hexamethylenediamine, N-(2-aminoethyl)-1,3-propanediamine, N,N′-1,2-ethanediylbis-1,3-propanediamine, dipropylenetriamine, m-xylylenediamine, p-xylylenediamine, 1,3-bisaminocyclohexylamine, isophorone diamine, or 4,4′-methylenebiscyclohexanamine, 4,4′-Methylenebis-(2-methyl-cyclohexanamine), m-phenylenediamine, diaminodiphenylmethane, diaminodiphenylsulfone, N-aminoethylpiperazine, 3,9-bis(3-aminopropyl)2,4,8,10-tetraoxaspiro (5,5)undecane, 4,7-dioxadecane-1,10-diamine, 1-propanamine,3,3′-(oxybis(2,1-ethanediyloxy))bis(diaminopropylated diethylene glycol), poly(oxy(methyl-1,2-ethanediyl)), alpha-(2-aminomethylethyl) omega-(2-aminomethylethoxy), triethyleneglycoldiamine, poly(oxy(methyl-1,2-ethanediyl)), alpha,alpha′-(oxydi-2,1-ethanediyl)bis(omega-(aminomethylethoxy)), bis(3-aminopropyl)polytetrahydrofuran, bis(3-aminopropyl)polytetrahydrofuran 750, poly(oxy(methyl-1,2-ethanediyl)), a-hydro-w-(2-aminomethylethoxy)ether with 2-ethyl-2-(hydroxymethyl)-1,3-propanediol, diaminopropyl dipropylene glycol and combinations thereof.

11. The epoxy resin composition of claim 1, wherein the primary curing agent is selected from the group consisting of diethylenetriamine, triethylenetetramine, 1,3-bisaminocyclohexylamine, 4,7-dioxadecane-1,10-diamine, isophoronediamine, 4,4′-methylenebiscyclohexanamine, 3,3′ Dimethyl 4,4′-methylenebiscyclohexanamine, N-aminoethylpiperazine, 4,7-dioxadecane-1,10-diamine,l-propanamine, 3,3′-(oxybis(2,1-ethanediyloxy))bis(diaminopropylated diethylene glycol), poly(oxy(methyl-1,2-ethanediyl)), alpha-(2-aminomethylethyl) omega-(2-aminomethylethoxy)triethylene glycol diamine, poly(oxy(methyl-1,2-ethanediyl))alpha,alpha′-(oxy(di-2,1-ethanediyl))bis(omega-(aminomethylethoxy)) and combinations thereof.

12. The epoxy resin composition of claim 1, wherein the primary curing agent is a polyamine comprising at least one or more multifunctional amine of structure 3. 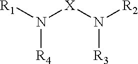
where R1 is CH2CH2CH2NH2; R2, R3 and R4 independently are H or CH2CH2CH2NH2; and X is CH2CH2 or CH2CH2CH2. In one embodiment R2 and R3 are not H simultaneously.

13. The epoxy resin composition of claim 1, wherein the secondary curing agent is an imidazole selected from the group consisting of 1-methyl imidazole, 2-methyl imidazole, 2-alkyl imidazole where the alkyl group can be an alkyl with 10 to 18 carbon atoms, 2-ethyl-4-methyl imidazole, 2-phenyl imidazole and 1-phenyl-2-methyl imidazole, 2-heptadecylimidazole, 1-cyanoethyl-2-phenylimidazole-trimellitate, 2-(β-(2′-methylimidazoyl-(1)))-ethyl-4-6-diamino-s-triazine, 2,4-dimethylimidazole 2-undecylimidazole, 2-heptadecenyl-4-methylimidazole, 2-heptadecylimidazole, 2-phenyl-4-methylimidazole, 1-benzyl-2-methylimidazole, 2-ethylimidazole, 2-isopropylimidazole, 2-phenyl-4-benzylimidazole, 2-vinylimidazole, 1-vinyl-2-methylimidazole, 1-propyl-2-methylimidazole, 1-(3-aminopropyl)-imidazole, butylimidazole 1-cyanoethyl-2-methylimidazole, 1-cyanoethyl-2-ethyl-4-methylimidazole, 1-cyanoethyl-2-undecylimidazole, 1-guanaminoethyl-2-methylimidazole, 1-cyanoethyl-2-isopropylimidazole, 1-cyanoethyl-2-phenylimidazole, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole, 2-methyl-4,5-diphenylimidazole, 2,3,5-triphenylimidazole, 2-styrylimidazole, 1-(dodecyl benzyl)-2-methylimidazole, 2-(2-hydroxyl-4-t-butylphenyl)-4,5-diphenylimidazole, 2-(2-methoxyphenyl)-4,5-diphenylimidazole, 2-(3-hydroxyphenyl)-4,5-diphenylimidazole, 2-(p-dimethyl-aminophenyl)-4,5-diphenylimidazole, 2-(2-hydroxyphenyl)-4,5-diphenylimidazole, di(4,5-diphenyl-2-imidazole)-benzene-1,4,2-naphthyl-4,5-diphenylimidazole, 1-benzyl-2-methylimidazole, 2-p-methoxystyrylimidazole and combinations thereof.

14. The epoxy resin composition of claim 1, wherein the secondary curing agent is a tertiary amine selected from the group consisting of methyldiethanolamine, triethanolamine, diethylamionpropylamine, benzyldimethyl amine, m-xylylenedi(dimethylamine), N,N′-dimethylpiperazine, N-methylpyrrolidine, N-methyl hydroxypiperidine, N,N,N′N′-trtramethyldiaminoethane, N,N,N′,N′,N′-pentamethyldiethylenetriamine, tributyl amine, trimethyl amine, diethyldecyl amine, triethylene diamine, N-methyl morpholine, N,N,N′N′-tetramethyl propane diamine, N-methyl piperidine, N,N′-dimethyl-1,3-(4-piperidino)propane, pyridine, 1,8-dizaobicyclo[5.4.0]undec-7-ene, 1,8-diazobicyclo[2.2.2]octane, 4-dimethylaminopyridine, 4-(N-pyrrolidino)pyridine, triethyl amine and 2,4,6-tris(dimethylaminomethyl)phenol, and combinations thereof.

15. The epoxy resin composition of claim 1, wherein the epoxy component includes glycidyl ether of polyhydric phenols.

16. The epoxy resin composition of claim 1, wherein the epoxy component includes an advanced dihydric phenol of the following structure: 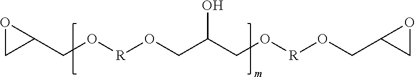
where m is an integer, and R is a divalent hydrocarbon radical of a dihydric phenol, and m has an average value between 0 and about 7.

17. The epoxy resin composition of claim 1, wherein the epoxy component is selected from the group consisting of 2,2-bis-(4-hydroxyphenyl)-propane, bis-(4-hydroxyphenyl)-methane and combinations thereof.

18. The epoxy resin composition of claim 1, the epoxy component is a multifunctional epoxy selected from the group consisting of diglycidyl ether of bisphenol-A, diglycidyl ether of bisphenol-F, epoxy novolac resin, and combinations thereof.

19. The epoxy resin composition of claim 1, wherein the epoxy component is selected from the group consisting of a cycloaliphatic epoxide; polyol polyglycidyl ether from polyethylene glycol, polypropylene glycol and polytetrahydrofuran; and
combinations thereof.

20. The epoxy resin composition of claim 1 wherein the epoxy component is a polyglycidyl amine from one or more of 2,2′-methylene dianiline, m-xylene dianiline, hydantoin, and isocyanate.

21. The epoxy resin composition of claim 1, further comprising a diluent selected from the group consisting of styrene oxide; cyclohexene oxide; glycidyl ethers of phenol, cresols, and tert-butylphenols; butanol; 2-ethylhexanol; C4 to C14 alcohols; and other alcohols or esters and combinations thereof.

22. An epoxy product comprising a reaction product of an epoxy resin composition, the epoxy resin composition comprising:
a curing component, the curing component comprising:
about 8% to about 70% by weight of the composition of a primary curing agent; and
about 0.001% to about 5% by weight of the composition of a secondary curing agent; and
about 30% to about 92% by weight of the composition of an epoxy component;
wherein a number of equivalents of reactive curative groups in the curing component is from about 0.50 to 0.98 times a number of epoxide equivalents present in the epoxy component.

23. The epoxy product of claim 22, wherein the number of equivalents of reactive curative groups in the curing component is from about 0.70 to 0.95 times a number of epoxide equivalents present in the epoxy component.

24. The epoxy product of claim 22, wherein the number of equivalents of reactive curative groups in the curing component is about 0.80 times a number of epoxide equivalents present in the epoxy component.

25. The epoxy product of claim 22, further comprising a reinforcing fiber.

26. The epoxy product of claim 25, wherein the reinforcing fiber is selected from the group consisting of woven or non-crimp fabrics, nonwoven webs or mats, fiber stands, staple fiber formed of continuous or discontinuous fiber and combinations thereof.

27. The epoxy product of claim 25, wherein the reinforcing fiber is selected from the group consisting of fiberglass, carbon fiber, carbon nanotubes nano composite fibers, polyaramide fibers, poly(p-phenylene benzobisoxazole) fiber, ultrahigh molecular weight polyethylene fibers, high and low density polyethylene fibers, polypropylene fibers, nylon fibers, cellulose fibers, natural fibers, biodegradable fibers and combinations thereof.

28. The epoxy product of claim 22, wherein a glass transition temperature of the epoxy product is greater than about 170° C.

29. The epoxy product of claim 22, wherein a glass transition temperature of the epoxy product is greater than about 220° C.

30. The epoxy product of claim 22, wherein a glass transition temperature of the epoxy product is greater than about 280° C.

31. A epoxy product of claim 22, wherein the epoxy product is a product selected from the group consisting of an adhesive, a laminate, a coating, a casting, a circuit board, a varnish, an encapsulant, a semiconductor, a general molding powder, a filament wound pipe, a storage tank, and a liner.
